(19) United States
(12) Patent Application Publication
(10) Pub. No.: US 2026/0074809 A1
(43) Pub. Date: Mar. 12, 2026

(54) TRANSMISSION MODE SELECTION FOR SERVING A USER EQUIPMENT IN A D-MIMO NETWORK

(71) Applicant: Telefonaktiebolaget LM Ericsson (publ), Stockholm (SE)

(72) Inventors: Pål Frenger, LInköping (SE); Joao Vieira, Hjärup (SE); Erik G. Larsson, LInköping (SE)

(21) Appl. No.: 19/106,364

(22) PCT Filed: Sep. 7, 2022
(86) PCT No.: PCT/SE2022/050795

§ 371 Date: Feb. 25, 2025

(51) Int. Cl. H04B 17/30; H04B 7/024; H04B 7/06

(52) U.S. Cl. CPC H04B 17/30; H04B 7/024; H04B 7/0628

(57) ABSTRACT

There is provided techniques for selecting transmission mode for APs to serve a user equipment in a D-MIMO network. Information of calibration status defining whether the radio transceiver chains per each pair of the APs are mutually calibrated or not is obtained. Channel characteristics of a propagation channel between each of the APs and the user equipment are obtained. Reception capability information of the user equipment is obtained. The transmission mode for at least one subset of the APs is selected as a function of the calibration status per each pair of the APs, the channel characteristics, and the reception capability information. Instructions are provided to the subset of the APs of the selected transmission mode to be used when serving the user equipment.

### TECHNICAL FIELD

Embodiments presented herein relate to a method, a centralized node, a computer program, and a computer program product for selecting transmission mode for access points to serve a user equipment in distributed multiple-input multiple-output network.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate technology component for the physical layer of the 6^{th} generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

For robust, high throughput, communication, the preferred way of D-MIMO operation is in time-division duplexing (TDD), relying on reciprocity of the propagation channel between the serving APs and the served UE. Pilot signals transmitted by the UEs can thereby be used for the APs to simultaneously obtain the uplink channel response (i.e., the channel response for the radio channel from the UEs towards the APs) and the downlink channel response (i.e., the channel response for the radio channel from the APs towards the UEs). This type of TDD operation especially facilitates reciprocity-based beamforming in the downlink.

For joint coherent beamforming from multiple APs to work properly in the downlink direction, the APs must be phase-aligned. This requires the use of sophisticated calibration protocols. These protocols typically involve performing mutual bi-directional measurements between pairs of APs. This does not scale very well with large networks, i.e., networks with large number of APs. Specifically, in a large network it may be possible to achieve good calibration locally among a set of APs located close to one another, but it is more difficult to achieve sufficiently accurate calibration globally across all APs in the network.

A specific difficulty is that many APs will not be able to hear each other. That is, wireless transmission of a signal from one of the APs will not reach, or at least not be decodable, by some other APs. In such scenarios it would not be beneficial to perform bi-directional pairwise measurements between the APs. In turn this implies that it will not be possible to mutually calibrate the APs. This issue is aggravated if some of the APs are movable (e.g., located on a vehicle), or if the radio environment is changing such that wireless links between the APs are blocked for an extended period of time, and perhaps in an unpredictable manner.

In addition, at high carrier frequencies this calibration becomes sensitive to variations in temperature and other external factors. This implies that the calibration needs to be performed comparatively often. Also, the calibration needs to be repeated if an AP, or at least parts of its radio transceiver chain, such as the frequency synthesizer, is powered off (for example to save power), which may happen on a short time scale.

As a result, heterogeneity might be introduced in the calibration status, in the sense that there are multiple groups of APs, where APs within a group are well phase-aligned with one another, but where there can be unknown, and significant, phase errors between different groups of APs. This implies that if APs from different groups were to participate in the service of a particular user equipment, joint coherent beamforming in the downlink direction might be infeasible.

Hence, there is still a need for an improved downlink transmission towards user equipment served by APs, such as APs in a D-MIMO network.

### SUMMARY

An object of embodiments herein is to address the above issues, and to enable downlink transmission towards user equipment served by APs, for example in scenarios where there are multiple groups of APs, where APs within a group are phase-aligned with one another, but where there can be unknown, and significant, phase errors between different groups of APs.

According to a first aspect there is presented a method for selecting transmission mode for APs to serve a user equipment in a D-MIMO network. Each of the APs comprises at least one radio transceiver chain. The method is performed by a centralized node in the D-MIMO network. The method comprises obtaining information of calibration status defining whether the radio transceiver chains per each pair of the APs are mutually calibrated or not. The method comprises obtaining channel characteristics of a propagation channel between each of the APs and the user equipment. The method comprises obtaining reception capability information pertaining to how many data streams the user equipment is capable of simultaneously receiving. The method comprises selecting the transmission mode for at least one subset of the APs as a function of the calibration status per each pair of the APs, the channel characteristics, and the reception capability information. The transmission mode at least defines how the antennas of the subset of the APs are to be used for serving the user equipment. The method comprises providing instructions to the subset of the APs of the selected transmission mode to be used when serving the user equipment.

According to a second aspect there is presented a centralized node for selecting transmission mode for APs to serve a user equipment in a D-MIMO network. Each of the APs comprises at least one radio transceiver chain. The centralized node comprises processing circuitry. The processing circuitry is configured to cause the centralized node to obtain information of calibration status defining whether the radio transceiver chains per each pair of the APs are mutually calibrated or not. The processing circuitry is configured to cause the centralized node to obtain channel characteristics of a propagation channel between each of the APs and the user equipment. The processing circuitry is configured to cause the centralized node to obtain reception capability information pertaining to how many data streams the user equipment is capable of simultaneously receiving. The processing circuitry is configured to cause the centralized node to select the transmission mode for at least one subset of the APs as a function of the calibration status per each pair of the APs, the channel characteristics, and the reception capability information. The transmission mode at least defines how the antennas of the subset of the APs are to be used for serving the user equipment. The processing circuitry is configured to cause the centralized node to provide instructions to the subset of the APs of the selected transmission mode to be used when serving the user equipment.

According to a third aspect there is presented a centralized node for selecting transmission mode for APs to serve a user equipment in a D-MIMO network. Each of the APs comprises at least one radio transceiver chain. The centralized node comprises an obtain module configured to obtain information of calibration status defining whether the radio transceiver chains per each pair of the APs are mutually calibrated or not. The centralized node comprises an obtain module configured to obtain channel characteristics of a propagation channel between each of the APs and the user equipment. The centralized node comprises an obtain module configured to obtain reception capability information pertaining to how many data streams the user equipment is capable of simultaneously receiving. The centralized node comprises a select module configured to select the transmission mode for at least one subset of the APs as a function of the calibration status per each pair of the APs, the channel characteristics, and the reception capability information. The transmission mode at least defines how the antennas of the subset of the APs are to be used for serving the user equipment. The centralized node comprises a provide module configured to provide instructions to the subset of the APs of the selected transmission mode to be used when serving the user equipment.

According to a fourth aspect there is presented a computer program for selecting transmission mode for APs to serve a user equipment in a D-MIMO network, the computer program comprising computer program code which, when run on a centralized node, causes the centralized node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable downlink transmission towards user equipment served by APs in scenarios where there are multiple groups of APs, where APs within a group are phase-aligned with one another, but where there can be unknown, and significant, phase errors between different groups of APs.

Advantageously, these aspects improve the downlink performance (such as transmission rate, throughput, network coverage, etc.) in scenarios with different groups of phase-aligned APs.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a flowchart of methods according to embodiments;

FIGS. 3, 4, and 5 schematically illustrate APs divided into calibration families according to embodiments;

FIG. 6 is a schematic diagram showing functional units of a centralized node according to an embodiment;

FIG. 7 is a schematic diagram showing functional modules of a centralized node according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

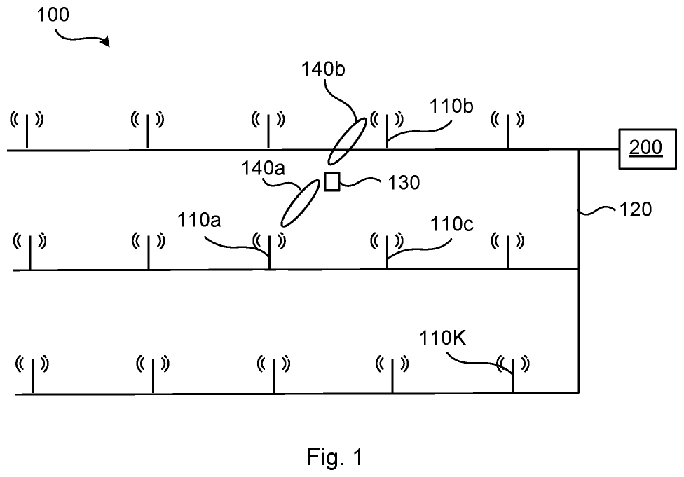

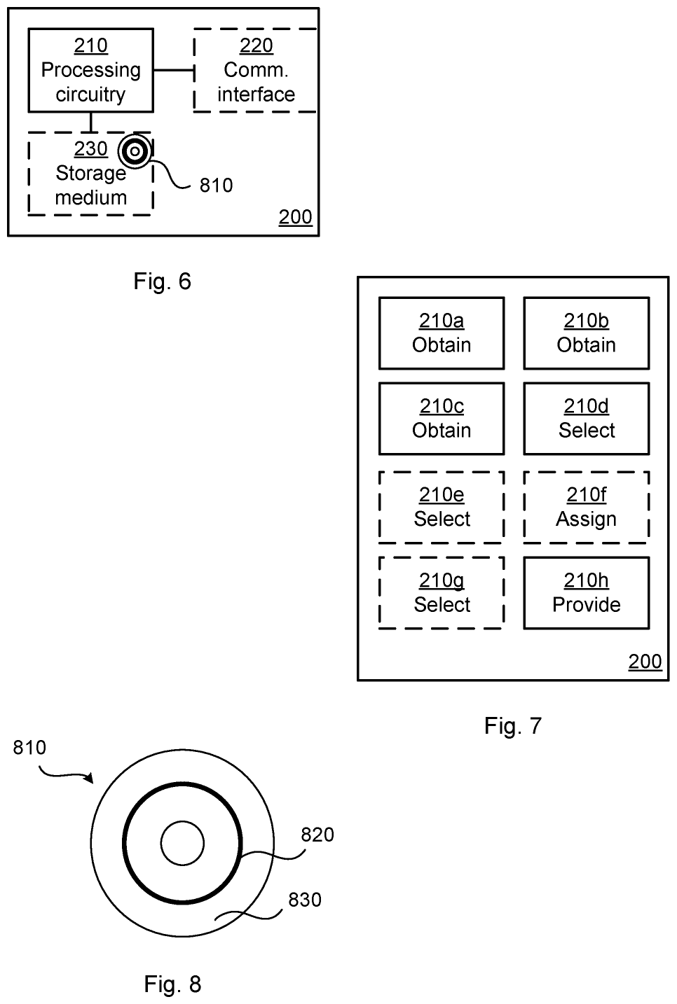

FIG. 1 is a schematic diagram illustrating a communication network 100 where embodiments presented herein can be applied. The communication network 100 comprises K APs, six of which are identified at reference numerals 110a, 110b, 110c, 110d, 110k, 110K. In this respect, the herein disclosed embodiments are not limited to any particular number of APs 110a:110K as long as there are at least two APs 110a:110K. Each AP 110a:110K could be a (radio) access network node, radio base station, base transceiver station, node B (NB), evolved node B (eNB), gNB, integrated access and backhaul (IAB) node, one or more distributed antenna, or the like. The APs 110a:110K operatively connected over interfaces 120 to a centralized node 200, which could represent an interface to a core network. The centralized node 200 could be a (radio) base station, or the like. Implementational aspects of the centralized node 200 will be disclosed below with reference to FIG. 6 and FIG. 7. The APs 110a:110K are configured to provide network access to user equipment (UE) 130.

Each such UE 130 could be any of a portable wireless device, mobile station, mobile phone, handset, wireless local loop phone, smartphone, laptop computer, tablet computer, wireless modem, wireless sensor device, Internet of Things (IOT) device, network equipped vehicle, or the like. Each such UE 130 is configured for wireless communication with the APs 110a:110K. In some examples, the APs 110a:110K use beamforming for this communication, as represented by beams 140a, 140b. In some aspects, the communications network 100 is a D-MIMO network. Hence, in some examples, the APs 110a:110K are part of a D-MIMO network.

In line with what disclosed above, there might be multiple groups of the APs 110a:110K, where APs within a group are phase-aligned with one another, but where there can be unknown, and significant, phase errors between different groups of APs. This results in challenges for downlink transmission towards served UEs 130.

The embodiments disclosed herein therefore relate to techniques for selecting transmission mode for APs 110a:110K to serve a user equipment 130 in a D-MIMO network 100. In order to obtain such techniques there is provided a centralized node 200, a method performed by the centralized node 200, a computer program product comprising code, for example in the form of a computer program, that when run on a centralized node 200, causes the centralized node 200 to perform the method.

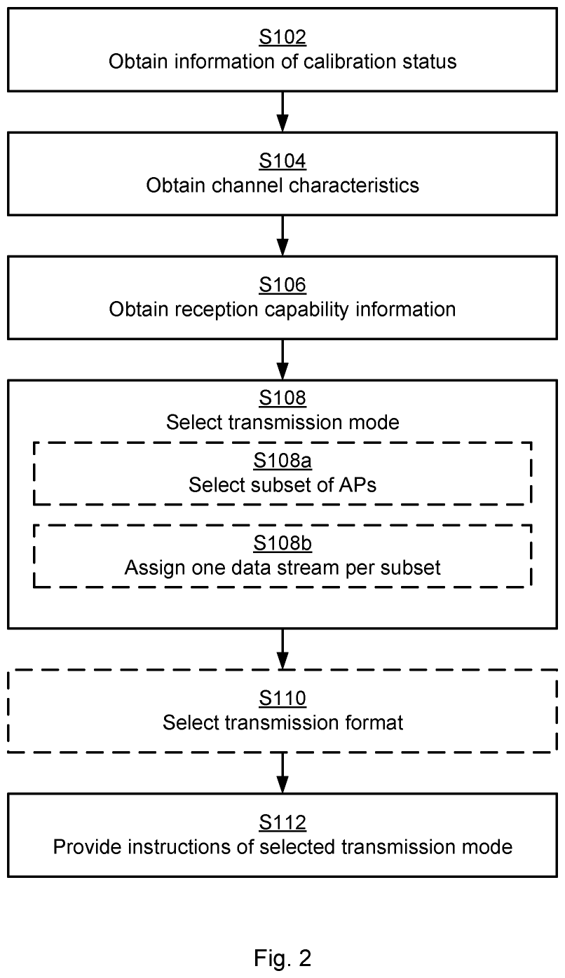

FIG. 2 is a flowchart illustrating embodiments of methods for selecting transmission mode for APs 110a:110K to serve a user equipment 130 in a D-MIMO network 100. Each of the APs 110a:110K comprises at least one radio transceiver chain. The methods are performed by a centralized node 200 in the D-MIMO network 100. The methods are advantageously provided as computer programs 820.

S102: The centralized node 200 obtains information of calibration status defining whether the radio transceiver chains per each pair of the APs 110a:110K are mutually calibrated or not. Examples of how it can be determined whether the radio transceiver chains per each pair of the APs 110a:110K are mutually calibrated or not will be disclosed below.

S104: The centralized node 200 obtains channel characteristics of a propagation channel between each of the APs 110a:110K and the user equipment 130. Examples of different types of channel characteristics will be disclosed below.

S106: The centralized node 200 obtains reception capability information pertaining to how many data streams the user equipment 130 is capable of simultaneously receiving.

S108: The centralized node 200 selects the transmission mode for at least one subset of the APs 110a:110K as a function of the calibration status per each pair of the APs 110a:110K, the channel characteristics, and the reception capability information. Below, such a subset of the APs 110a:110K will be referred to as a transmission set. The transmission mode at least defines how the antennas of the subset of the APs 110a:110K are to be used for serving the user equipment 130. Further aspects of different transmission modes and how the different transmission modes might be selected will be disclosed below.

S112: The centralized node 200 provides instructions to the subset of the APs 110a:110K of the selected transmission mode to be used when serving the user equipment 130.

Embodiments relating to further details of selecting transmission mode for APs 110a:110K to serve a user equipment 130 in a D-MIMO network 100 as performed by the centralized node 200 will now be disclosed with continued reference to FIG. 2.

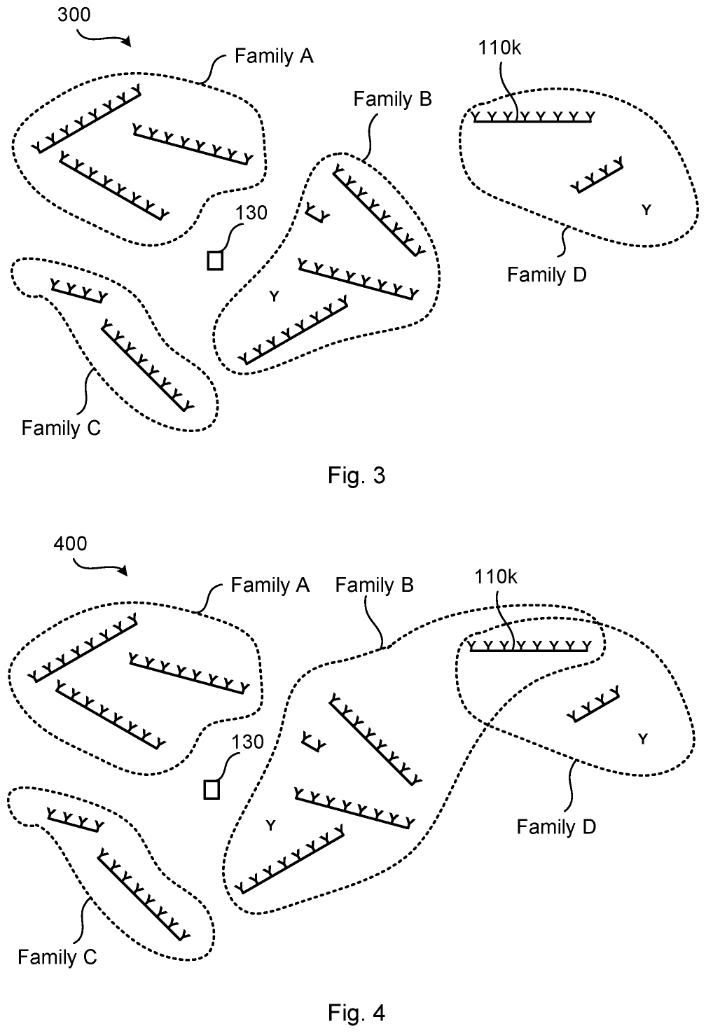

Parallel reference will also be made to FIGS. 3, 4, and 5, which at 300, 400, and 500 show examples of APs (as represented by their antenna arrays, with either one, two, four, or eight antenna elements per antenna array) serving a user equipment 130, where the APs have been divided into different groups.

In the subsequent description, the following terminology is used.

A calibration family is a set of APs that are phase-aligned (and thus capable of joint coherent DL transmissions) to some extent. In FIGS. 3, 4, and 5 examples are given where four calibration families are illustrated in each figure.

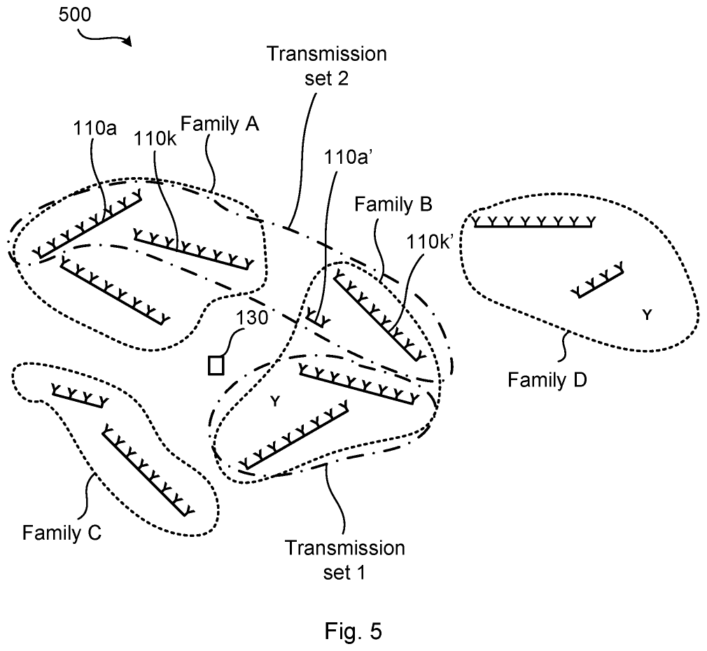

A transmission set is a specific set of APs that engage in the transmission of a specific data stream. In FIG. 5 is given an example where there are two transmission sets.

A transmission mode is a way of configuring the transmission of a data stream from multiple APs, which could be, for example, joint coherent beamforming transmission, diversity scheme/space-time code transmission, multi-stream transmission, single frequency network (SFN) transmission, repetition transmission, etc.

Aspects of calibration families will be disclosed next.

FIG. 3 shows at an example with APs divided into four calibration families, denoted Family A, Family B, Family C and Family D. APs in Family A are mutually calibrated relative to one another, such that any combination of APs in Family A can (but do not have to) perform joint coherent transmission towards the UE in downlink. Analogous conditions hold for Family B, Family C and Family D. As further illustrated in FIG. 3, the APs, even within each calibration family, may have different number of antennas, and hence radio transceiver chains. FIG. 3 is an example where all calibration families are disjoint.

Some, or even all, calibration families might partly overlap with each other. That is, one and the same AP may at the same point in time belong to more than one calibration family. An example of this is illustrated in FIG. 4 where there are four calibration families, and where AP 110k belongs to both Family B and Family D.

Aspects of transmission sets will be disclosed next.

In FIG. 5 is shown an example of a possible assignment of S=2 transmission sets; Transmission set 1 and Transmission set 2. Here, those of the APs not being assigned to any transmission set do not participate in the transmission towards the user equipment 130. In the illustrated example, all APs in Transmission set 1 belong to the same calibration family (i.e., Family B), whereas Transmission set 2 is composed of APs 110a, 110k belonging to Family A and APs 110a′, 110k′ belonging to Family B. The centralized node may decide, as the preferred but not the only possible option, to have all APs in Transmission set 1 performing joint coherent beamforming of the data stream. Further, the centralized node may determine to have the APs in Transmission set 1 involved in a diversity scheme, or involved in a mix of joint coherent transmissions and a diversity scheme. Still further, the centralized node may determine that a diversity scheme of order two (e.g., a space-time code, such as the Alamouti scheme) is used for Transmission set 2, but that joint coherent beamforming is used only by the APs within each calibration family. This joint coherent beamforming could be, for example, local zero-forcing, not to be confused with joint zero-forcing involving all APs in the network, which requires full phase calibration among all participating APs. In any case, the centralized node should not, in this case, determine that joint coherent beamforming be used by all APs in Transmission set 2. However, the centralized node might, for Transmission set 2, determine that joint coherent beamforming is to be used within each of Family A and Family B and that a diversity scheme is to be used between Family A and Family B. In particular, in some embodiments, when according to the calibration status, the radio transceiver chains of the APs 110a:110K within each subset are mutually calibrated, the selected transmission mode involves any, or any combination, of: joint coherent beamforming from the subset of APs 110a:110k, diversity transmission from the subset of APs 110a, 110k and at least one other subset of APs 110a′, 110k′ (with reference numerals as in FIG. 5). Further, in some embodiments, when according to the calibration status, all the radio transceiver chains of the APs 110a:110K within each subset are not mutually calibrated, the selected transmission mode involves diversity transmission from the subset of APs 110a:110K.

Aspects of transmissions using the APs in each transmission set will be disclosed next.

Each transmission set, s=1, . . . , S, is assigned one data stream each. Consider transmission set s. Let f be the number of calibration families that the APs in transmission set s belong to. Then a diversity scheme of at least order f should be used. Hence, in some embodiments, the diversity transmission is of order f when there are f different mutually calibrated groups of radio transceiver chains within the subset of APs 110a:110K. For example, if space-time block codes are used, then a code for at least f antenna ports needs to be selected, where each antenna port being associated with at least one radio transceiver branch in each calibration family. For f=2, one preferred choice is the Alamouti scheme. For f>2, for example, a space-time code for f antenna ports can be used, which could be orthogonal or non-orthogonal. Alternatively, a delay diversity scheme with f−1 appropriately selected delays, or an appropriately designed space-time trellis code, can be used. For f=1, joint coherent beamforming of the data stream can be performed. Hence, in some embodiments, the diversity transmission is of order f when there are f subsets of APs 110a:110K in total serving the user equipment 130.

Aspects of determining the calibration families will be disclosed next.

The calibration families might be determined based on how well the APs are aligned in phase. In particular, in some embodiments, the radio transceiver chains per each pair of the APs 110a:110K are considered mutually calibrated when all the radio transceiver chains are phase-aligned with each other. Define eᵢⱼ to be the phase alignment error between APs i and j.

In one example, this alignment error is computed as follows. Let εᵢⱼ be an estimate of the maximum phase alignment error between the radio transceiver (or at least transmit) branch for any of the antennas of AP i and the radio transceiver (or at least receive) branch in any of the antennas of AP j. Then take eᵢⱼ=max(εᵢⱼ, εⱼᵢ). By construction, eᵢⱼ=eⱼᵢ.

In another example, the estimation of the phase alignment error between two APs is performed based on the signal strength of bi-directional measurements, and an estimate of the variance of additive measurement noise. This is based on the assumption that he higher the signal to noise ratio (SNR) of the wireless link between the two APs is, the lower the phase alignment error will be. For example, an equally weighted average of the received signal strength between the forward and reverse measurements, which jointly constitute a bi-directional measurement between two APs, is first calculated. This result as well as an estimate of the additive noise variance is then compared against a pre-computed look-up table which provides estimates of the phase alignment error, i.e., eᵢⱼ=eⱼᵢ, between the two APs under consideration.

From the collection {eᵢⱼ} for all pairs i, j of APs, an undirected graph G can be constructed in which the nodes represent APs and in which a link between two nodes signify that the corresponding APs are accurately enough phase-calibrated relative with respect to one another for joint coherent beamforming in the downlink to work. One way to define the graph G is to take a pre-determined alignment error tolerance threshold t, and then let the (i, j): th element of the adjacency matrix of G be equal to 1 such that nodes i and j are connected if |eᵢⱼ|<τ and 0 otherwise, such that nodes i and j are disconnected. In the event that G is fully connected, all APs will belong to the same calibration family and there is no grouping of APs to be performed. If G is not fully connected, then the cliques of G can be identified, where each clique can represent a respective calibration family. By definition, a clique is a completely connected subgraph. Cliques can overlap. Computationally, standard graph algorithms may be used to find the cliques.

In one example, the threshold τ is adapted based on what transmission mode and what transmission format that will be used. For example, if zero-forcing interference cancellation will be used in the downlink, and/or if high modulation orders will be used for the downlink, then the phase alignment error that can be tolerated between two participating APs is less than if only conjugate beamforming (e.g., maximum-ratio transmission) is to be used.

Aspects of determining the transmission sets will be disclosed next.

In general terms, depending on the scenario and its performance objectives, the centralized node can determine that several data streams are to be multiplexed or that only a single data stream is to be transmitted. Depending on the characteristics of the propagation channel, the centralized node can further decide to use a diversity scheme.

In one example, high data rates are prioritized and the APs are optimized for spatial multiplexing. The centralized node can for example determine how many spatial streams, N, each user equipment should receive (for example, given by the number of antennas or antenna ports at the user equipment), and for each such spatial stream, determine a transmission set, such that S=N. Alternatively, the centralized node can determine a minimum signal to interference plus noise ratio (SINR) threshold, T, and then determine how many transmission sets that can be formed such that the resulting SINR in each transmission set is at least equal to T.

For example, the centralized node might exhaustively test all possible assignments of APs to transmission sets, such that APs within a transmission set belong to the same calibration family and such that the resulting SINR for the data stream associated with each transmission set is ≥T. In some examples, link parameters involved in the calculation of the downlink SINR can be estimated via uplink measurements and/or reports from the user equipment of downlink measurements.

In another example, robustness to blocking and strong interference is prioritized. Such prioritization may be based on the nature of the traffic. As a non-limiting illustrative example, ultra-reliable low latency communications (URLLC) traffic requires high link robustness in the transmission. The centralized node can then, for example, obtain historical channel state information indicating that some APs have a small pathloss but are subject to frequent blocking (such that the signal strength varies between randomly very good and very poor). In this case, two or more such APs may be assigned to one transmission set, with the intent to apply a diversity scheme.

Furthermore, in some non-limiting examples, the channel characteristics is provided in terms of any, or any combination, of: pathloss, second-order statistics of the propagation channel, blockage, interference characteristics.

Aspects of determining the transmission mode for each transmission set will be disclosed next.

Once transmission sets have been determined, a data stream is associated with each transmission set. One transmission mode per each transmission set can then be configured.

In particular, in some embodiments, the centralized node 200 is configured to perform (optional) steps S108a and S108b as part of selects the transmission mode in step S108.

S108a: The centralized node 200 selects at least one subset of the APs 110a:110K. Each subset comprises at least one of the APs 110a:110K. According to the calibration status, the radio transceiver chains of the APs 110a:110K within each subset are either mutually calibrated or not.

S108b: the centralized node 200 assigns one of the data streams per each of the selected subsets.

In some embodiments, the radio transceiver chains are phase-aligned, and thus mutually calibrated, with each other when the radio transceiver chains collectively have a phase alignment uncertainty smaller, or equal to, an uncertainty threshold value. The phase alignment uncertainty might be equal to a standard deviation of a phase alignment error post calibration of the radio transceiver chains.

In some aspects, the uncertainty threshold value is adapted based on what transmission mode and what transmission format that will be used. That is, in some embodiments, the uncertainty threshold value is set depending on which transmission modes that are available to be selected.

In one example, if the APs within a given transmission set experience stable radio propagation channels, and the APs belong to the same calibration family, joint coherent transmission is performed. Here, stable radio propagation channel can mean, for example, that the centralized node, or the APs themselves, has observed, based on historical channel state information, that the variability in signal strength is small (i.e., the probability of blocking is low). Thereby, according to an embodiment, when, according to the channel characteristics, the propagation channel is detected to have a variability below a variability threshold value, the selected transmission mode involves joint coherent beamforming from the subset of APs 110a:110K. That is, joint coherent transmission can be performed for APs 110a:110K within a given transmission set that have stable channels and that belong to the same calibration family.

In another example, the centralized node checks if the calibration error eᵢⱼ between any pair of APs (i, j) belonging to the transmission set is less than a predetermined threshold. The threshold might be selected as function of the targeted spectral efficiency. For example, if zero-forcing beamforming is to be used, extra high calibration accuracy may be required. Thereby, according to an embodiment, when according to the channel characteristics, the propagation channel has a variability above a variability threshold value, the selected transmission mode involves diversity transmission from the subset of APs 110a:110K. That is, a diversity scheme can be applied for APs 110a:110K that within a given transmission set have channels that fluctuate significantly.

In one example, if the APs within a given transmission set experience radio propagation channels that fluctuate significantly, a diversity scheme is applied. For example, fluctuation may be defined as the probability of link blocking (based on historical channel state information). A model can be defined that determines how the link quality evolves over time, for example a two-state (Gilbert-Elliott) Markov-chain model, where the two states represent “good link” and “blocked link”, respectively, and where a transition between the two states occurs with probabilities that can be estimated from historical data. Such a model can also be of higher order and capture the correlation between blocking of the different links. For example, for two links, a four-state Markov chain can be defined whose states represent “both links good”, “both links blocked”, “link 1 good and link 2 blocked” and “link 1 blocked and link 2 good”. Estimation methods from the literature on hidden Markov models can be used to estimate the parameters of such Markov models based on historical channel state information. Based on a so-obtained model, the centralized node can predict how likely it is that the different links from the different APs in the transmission set are good, and if is determined that some links are likely to be blocked then a diversity scheme is selected for the transmission format.

Further, in some embodiments, the transmission mode is selected with an objective to maximize a utility metric. According to non-limiting examples, the utility metric pertains to any of: maximizing the number of selected subset of APs 110a:110K, maximizing the minimum SINR for the subset of APs 110a:110K for serving the user equipment 130, and/or robustness to blocking. The transmission mode might thereby be selected with an objective to have as many transmission sets as possible, with an objective to have the minimum effective SINR among the transmission sets as large as possible, and/or with an objective to have robustness to blocking.

Aspects of determining the transmission format for each data stream will be disclosed next.

Once the transmission sets and transmission modes have been determined, a transmission format for each transmission set can be determined.

In particular, in some embodiments, the centralized node 200 is configured to perform (optional) step S110.

S110: The centralized node 200 selects a transmission format for the subset of the APs 110a:110K as a function of the calibration status per each pair of the APs 110a:110K, the channel characteristics, and the reception capability information. The instructions provided to the APs 110a:110K comprises instructions of the selected transmission format to be used when serving the user equipment 130.

There could be different types of transmission formats. In some non-limiting examples, the transmission format at least defines which modulation and coding scheme (MCS) the subset of the APs 110a:110K is to use when serving the user equipment 130.

Further, even if all APs 110a:110K can perform joint coherent transmission, there might still be some calibration errors. Based on an error estimate of the calibration errors, the centralized node can estimate how the calibration errors might impact the transmission towards the user equipment, and thus impact the selection of the transmission format. Therefore, in some embodiments, the information of the calibration status comprises a calibration error estimate, and the transmission format further is selected as a function of the calibration error estimate.

In one example, the selection of transmission format is done based on uplink pilot signals (i.e., pilot signals transmitted by the user equipment and received by the APs) only. From measurement on the uplink pilot signals as received by the APs, a signal strength estimate may be formed. This signal strength estimate can then be mapped onto a transmission format. Additionally, this mapping can also be based on information on the calibration status (which may comprise, estimates of the standard deviation of the phase alignment errors between the APs involved in the transmission).

Since uplink and downlink SINR may differ, depending on the interference situation and depending especially on the possible presence of uncontrollable interference from out-of-system or out-of-band, alternatives are possible. Specifically, in one example, the APs might transmit downlink reference signals towards the UE, where the user equipment estimates the resulting signal quality (such as SINR). This signal quality can be reported back to the centralized node from the user equipment over a feedback channel to the APs. The centralized node might then use the signal quality to determine an appropriate transmission format for the data transmission towards the user equipment.

In yet another example, the centralized node might select a preliminary transmission format to transmit data in the downlink towards the user equipment from the APs. Once this data is received at the user equipment, the user equipment can determine an estimate of the resulting link error performance and signal quality, and feed these back to the centralized node via the APs. Based on the so-obtained feedback, the centralized node can adjust the transmission format accordingly.

In summary, based on calibration signaling as well as uplink/downlink signaling, the centralized node might determine an initial list of APs that could potentially be involved in the service of a particular user equipment. Depending on the calibration status of these APs, the centralized node determines from the list of APs a number of AP calibration families. Each such family (also referred to as a subset) contains at least one AP. A set of APs are deemed to belong to the same calibration family if they are all calibrated accurately enough relative to one another (i.e., pair-wisely) such that they can operate phase-coherently together in the downlink when serving the same user equipment. In contrast, two APs that belong to different calibration families can have phase alignment errors between themselves that prohibit them to perform joint transmission. The user equipment is to be served with some number, S, of independent data streams. Among the available APs, a number of transmission sets are determined. Of the transmission sets, some may be active and some may be inactive (i.e., unused). Each active transmission set is associated with exactly one data stream, such that the number of active transmission sets equals the number of streams, S. That stated, nothing precludes two transmission sets from being identical (i.e., comprising the same APs), such that effectively more than one data stream is associated with the same set of APs. The centralized node further determines for each active transmission set a transmission mode that can be one of i) joint coherent beamforming, ii) and a diversity scheme (e.g., space-time coding, spatial repetition, transmission of independent data streams from each transmission set, etc.). In case an AP is alone in a transmission set, that AP simply transmits the data stream associated with that set, using appropriate beamforming. The centralized node further determines, for each active transmission set, a transmission format that, for example, specifies the exact modulation and coding scheme to be used for the data stream associated to the active transmission set.

FIG. 6 schematically illustrates, in terms of a number of functional units, the components of a centralized node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the centralized node 200 to perform a set of operations, or steps, as disclosed above. For example, the storage medium 230 may store the set of operations, and the processing circuitry 210 may be configured to retrieve the set of operations from the storage medium 230 to cause the centralized node 200 to perform the set of operations. The set of operations may be provided as a set of executable instructions.

Thus, the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The centralized node 200 may further comprise a communications interface 220 at least configured for communications with other entities, functions, nodes, and devices, such as at least the APS 110a:110K. As such the communications interface 220 may comprise one or more transmitters and receivers, comprising analogue and digital components. The processing circuitry 210 controls the general operation of the centralized node 200 e.g. by sending data and control signals to the communications interface 220 and the storage medium 230, by receiving data and reports from the communications interface 220, and by retrieving data and instructions from the storage medium 230. Other components, as well as the related functionality, of the centralized node 200 are omitted in order not to obscure the concepts presented herein.

FIG. 7 schematically illustrates, in terms of a number of functional modules, the components of a centralized node 200 according to an embodiment. The centralized node 200 of FIG. 7 comprises a number of functional modules; an obtain module 210a configured to perform step S102, an obtain module 210b configured to perform step S104, an obtain module 210c configured to perform step S106, a select module 210d configured to perform step S108, and a provide module 210h configured to perform step S112. The centralized node 200 of FIG. 7 may further comprise a number of optional functional modules, such as any of a select module 210e configured to perform step S108a, an assign module 21of configured to perform step S108b, and a select module 210g configured to perform step S112.

In general terms, each functional module 210a:210h may in one embodiment be implemented only in hardware and in another embodiment with the help of software, i.e., the latter embodiment having computer program instructions stored on the storage medium 230 which when run on the processing circuitry makes the centralized node 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a:210h may be implemented by the processing circuitry 210, possibly in cooperation with the communications interface 220 and/or the storage medium 230. The processing circuitry 210 may thus be configured to from the storage medium 230 fetch instructions as provided by a functional module 210a:210h and to execute these instructions, thereby performing any steps as disclosed herein.

The centralized node 200 may be provided as a standalone device or as a part of at least one further device. For example, the centralized node 200 may be provided in a node of the access network or in a node of the core network. Alternatively, functionality of the centralized node 200 may be distributed between at least two devices, or nodes. These at least two nodes, or devices, may either be part of the same network part (such as the radio access network or the core network) or may be spread between at least two such network parts. That is, part of the centralized node 200 might be implemented by at least one of the APs 110a:110K. In general terms, instructions that are required to be performed in real time may be performed in a device, or node, operatively closer to the APs 110a:110K than instructions that are not required to be performed in real time.

Thus, a first portion of the instructions performed by the centralized node 200 may be executed in a first device, and a second portion of the of the instructions performed by the centralized node 200 may be executed in a second device; the herein disclosed embodiments are not limited to any particular number of devices on which the instructions performed by the centralized node 200 may be executed.

Hence, the methods according to the herein disclosed embodiments are suitable to be performed by a centralized node 200 residing in a cloud computational environment. Therefore, although a single processing circuitry 210 is illustrated in FIG. 6 the processing circuitry 210 may be distributed among a plurality of devices, or nodes. The same applies to the functional modules 210a:210h of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for selecting transmission mode for access points (APs) to serve a user equipment in a distributed multiple input multiple output (D-MIMO) network wherein each of the APs comprises at least one radio transceiver chain, wherein the method is performed by a centralized node in the D-MIMO network, and wherein the method comprises:
obtaining information of calibration status defining whether the radio transceiver chains per each pair of the APs are mutually calibrated or not;
obtaining channel characteristics of a propagation channel between each of the APs and the user equipment;
obtaining reception capability information pertaining to how many data streams the user equipment is capable of simultaneously receiving;
selecting the transmission mode for at least one subset of the APs as a function of the calibration status per each pair of the APs the channel characteristics, and the reception capability information, wherein the transmission mode at least defines how the antennas of the subset of the APs are to be used for serving the user equipment; and
providing instructions to the subset of the APs of the selected transmission mode to be used when serving the user equipment

2. The method according to claim 1, wherein selecting the transmission mode comprises:
selecting at least one subset of the APs, wherein each subset comprises at least one of the APs, wherein, according to the calibration status, the radio transceiver chains of the APs within each subset are either mutually calibrated or not; and
assigning one of the data streams per each of the selected subsets.

3. The method according to claim 1, wherein the radio transceiver chains per each pair of the APs are mutually calibrated when all the radio transceiver chains are phase-aligned with each other.

4. The method according to claim 1, wherein the radio transceiver chains are phase-aligned with each other when the radio transceiver chains collectively have a phase alignment uncertainty smaller, or equal to, an uncertainty threshold value.

5. The method according to claim 4, wherein the phase alignment uncertainty is equal to a standard deviation of a phase alignment error post calibration of the radio transceiver chains.

6. The method according to claim 4, wherein the uncertainty threshold value is set depending on which transmission modes that are available to be selected.

7. The method according to claim 1, wherein the channel characteristics is provided in terms of any, or any combination, of: pathloss, second-order statistics of the propagation channel, blockage, interference characteristics.

8. The method according to claim 1, wherein, when according to the calibration status, the radio transceiver chains of the APs within each subset are mutually calibrated, the selected transmission mode involves any, or any combination, of: joint coherent beamforming from the subset of APs, diversity transmission from the subset of APs and at least one other subset of APs.

9. The method according to claim 8, wherein the diversity transmission is of order f when there are f subsets of APs in total serving the user equipment.

10. The method according to claim 1, wherein, when according to the calibration status, all the radio transceiver chains of the APs within each subset are not mutually calibrated, the selected transmission mode involves diversity transmission from the subset of APs.

11. The method according to claim 1, wherein, when according to the channel characteristics, the propagation channel is detected to have a variability below a variability threshold value, the selected transmission mode involves joint coherent beamforming from the subset of APs.

12. The method according to claim 1, wherein, when according to the channel characteristics, the propagation channel has a variability above a variability threshold value, the selected transmission mode involves diversity transmission from the subset of APs.

13. The method according to claim 10, wherein the diversity transmission is of order f when there are f different mutually calibrated groups of radio transceiver chains within the subset of APs.

14. The method according to claim 1, wherein the transmission mode is selected with an objective to maximize a utility metric.

15. The method according to claim 14, wherein the utility metric pertains to any of: maximizing number of selected subset of APs, maximizing minimum signal to interference plus noise ratio for the subset of APs for serving the user equipment robustness to blocking.

16. The method according to claim 1, wherein the method further comprises:
selecting a transmission format for the subset of the APs as a function of the calibration status per each pair of the APs, the channel characteristics, and the reception capability information, and wherein the instructions provided to the APs comprises instructions of the selected transmission format to be used when serving the user equipment.

17. The method according to claim 16, wherein the transmission format at least defines which modulation and coding scheme the subset of the APs is to use when serving the user equipment.

18. The method according to claim 1, wherein the information of the calibration status comprises a calibration error estimate, and wherein the transmission format further is selected as a function of the calibration error estimate.

19. A centralized node for selecting transmission mode for access points (APs) to serve a user equipment in a distributed multiple input multiple output (D-MIMO) network, wherein each of the APs comprises at least one radio transceiver chain, the centralized node comprising processing circuitry the processing circuitry being configured to cause the centralized node to:
obtain information of calibration status defining whether the radio transceiver chains per each pair of the APs are mutually calibrated or not;
obtain channel characteristics of a propagation channel between each of the APs and the user equipment;
obtain reception capability information pertaining to how many data streams the user equipment is capable of simultaneously receiving;
select the transmission mode for at least one subset of the APs as a function of the calibration status per each pair of the APs, the channel characteristics, and the reception capability information, wherein the transmission mode at least defines how the antennas of the subset of the APs are to be used for serving the user equipment; and
provide instructions to the subset of the APs of the selected transmission mode to be used when serving the user equipment.

20-21. (canceled)

22. A non-transitory computer readable medium storing instructions for selecting transmission mode for access points (APs) to serve a user equipment in a distributed multiple input multiple output (D-MIMO) network, wherein each of the APs comprises at least one radio transceiver chain, the instructions being executable by processing circuitry of a centralized node, whereby the centralized node is caused to:
obtain information of calibration status defining whether the radio transceiver chains per each pair of the APs are mutually calibrated or not;
obtain channel characteristics of a propagation channel between each of the APs and the user equipment;
obtain reception capability information pertaining to how many data streams the user equipment is capable of simultaneously receiving;
select the transmission mode for at least one subset of the APs as a function of the calibration status per each pair of the APs, the channel characteristics, and the reception capability information, wherein the transmission mode at least defines how the antennas of the subset of the APs are to be used for serving the user equipment; and
provide instructions to the subset of the APs of the selected transmission mode to be used when serving the user equipment.

23. (canceled)
